(19) United States
(12) Patent Application Publication
(10) Pub. No.: US 2009/0296607 A1
(43) Pub. Date: Dec. 3, 2009

(54) Computer Telephony for Cellular Phones

(75) Inventor: Jerry Pettersson, Uppsala (SE)

Correspondence Address: BIRCH STEWART KOLASCH & BIRCH, PO BOX 747, FALLS CHURCH, VA, 22040-0747, US

(73) Assignee: IP DRUM HOLDING S.A., Luxembourg (LU)

(21) Appl. No.: 11/920,048

(22) PCT Filed: Apr. 27, 2006
(86) PCT No.: PCT/SE2006/000490

§ 371 Date: Aug. 12, 2009

(30) Foreign Application Priority Data
May 9, 2005 (SE) 0501067-3

(51) Int. Cl. H04L 12/66; H04W 92/02; H04L 12/18

(52) U.S. Cl. 370/260; 370/328; 370/352

(57) ABSTRACT

The present invention relates to a computer telephony terminal provided in a personal computer (10) and includes a computer telephony handling unit, a first cellular phone (12), and a control unit. The control unit is arranged to order the setting up of a voice-over-IP connection over a computer network (18) to a second terminal (14) based on phone call information received by the first cellular phone from a second known cellular phone (16) via a cellular network (20) or to order the setting up of a cellular voice connection from the first cellular phone to the second known cellular phone based on a received voice-over-IP call from the second terminal received by the computer telephony handling unit via a voice-over-IP connection.

### TECHNICAL FIELD OF THE INVENTION

The present invention relates to the field of computer telephony and more particularly to the field of providing computer telephony to cellular phone users.

### DESCRIPTION OF RELATED ART

With the introduction of computer telephony, there has been introduced a revolution in the field of telephony. The costs of these types of calls are today very low or sometimes non-existent.

Today there are also many cellular phones used. The cellular phone has allowed users a great freedom of mobility and accessibility. However the costs can in many instances be very high for cellular phone users, especially if calls are placed that are long distance calls, calls to other networks or to other countries.

There is therefore a need for allowing users of cellular phones to be able to continue to use their phones and keep their freedom of mobility while at the same time provide computer telephony so that they can reduce the calling costs.

### SUMMARY OF THE INVENTION

The present invention is directed towards solving the problem of providing computer telephony capabilities to cellular phone users.

One object of the present invention is thus to provide computer telephony capabilities to cellular phone users.

According to a first aspect of the present invention, this object is achieved by a computer telephony terminal provided in a personal computer and comprising:
a computer telephony handling unit arranged to set up and receive peer-to-peer voice-over-IP telephone calls to and from other terminals via voice-over-IP connections over a computer network,
a first cellular phone arranged to set up and receive cellular phone voice calls to and from other cellular phones via cellular voice connections over a cellular phone network, and
a control unit arranged to order the setting up of a voice-over-IP connection over the computer network to a second terminal based on phone call information received by the first cellular phone from a second known cellular phone via a the cellular network or
to order the setting up of a cellular voice connection from the first cellular phone to the second known cellular phone based on a received voice-over-IP call from the second terminal received by the computer telephony handling unit via a voice-over-IP connection.

According to a second aspect of the present invention, this object is achieved by a computer program product for setting up a telephone call between a user of a cellular phone and another party using a computer network via a personal computer having a computer telephony handling unit arranged to set up and receive peer-to-peer voice-over-IP telephone calls to and from other terminals via voice-over-IP connections over a computer network and to be connected to a first cellular phone arranged to set up and receive cellular phone voice calls to and from other cellular phones via cellular voice connections over a cellular phone network,

said computer program product comprising computer program code, to make said personal computer execute, when said computer program code is loaded in the personal computer:
order the computer telephony handling unit to set up f a voice-over-IP connection over the computer network to a second terminal based on phone call information received by the first cellular phone from a second known cellular phone via a the cellular network or
order the first cellular phone to set up a cellular voice connection from the first cellular phone to the second known cellular phone based on a received voice-over-IP call from the second terminal received by the computer telephony handling unit via a voice-over-IP connection.

According to a third aspect of the present invention, this object is achieved by a method of setting up a telephone call between a user of a cellular phone and another party using a computer network comprising the steps of:
receiving, in a first computer telephony terminal, a peer-to-peer voice-over-IP telephone call from a second terminal via a voice-over IP connection set up by the second terminal over the computer network, and
ordering a first cellular phone to set up of a cellular voice connection to a second known cellular phone via a cellular network, such that voice signals received by the computer telephony handling unit over the voice-over-IP connection can be forwarded to the first cellular phone for transmission over the cellular connection to the second cellular phone and voice signals received by the first cellular phone over the cellular phone connection can be forwarded from the second cellular phone to the second computer over the voice-over-IP connection.

According to a fourth aspect of the present invention this object is achieved by a method of setting up a telephone call between a user of a cellular phone and another party using a computer network comprising the steps of:
receiving, from a first cellular phone, computer telephony phone call information that the first cellular phone has received from a known second cellular phone, and
ordering the setting up of a voice-over-IP connection over the computer network to a second terminal based on said phone call information.

The invention has the following advantages. It allows a user to lower his phone bills considerably in a simple manner, especially if the user is placing a lot of international calls, Since computer telephony is used, which is often provided at low or very small, costs, the remaining costs are the costs associated with the local cellular network. These costs are then often very low. In this way it is thus possible to provide a cellular phone user with the capability to place long distance or international calls at a cost that is virtually the same as the costs in a local network.

### BRIEF DESCRIPTION OF THE DRAWINGS

The present invention will now be described in more detail in relation to the enclosed drawings, in which:

FIG. 1 shows a block schematic of a computer telephony terminal comprising a PC and a first cellular phone connected to a computer network and a wireless network,

FIG. 2 shows a block schematic of the computer telephony terminal according to one embodiment of the present invention,

FIG. 3 shows a block schematic of a computer telephony terminal according to another embodiment of the present invention, and

FIG. 4 schematically shows a computer readable medium in the form of a CD Rom disc comprising computer program code for performing the method according to the invention.

### DETAILED DESCRIPTION OF EMBODIMENTS

The invention is directed towards enabling the use of peer-to-peer IP telephony in relation to cellular phones.

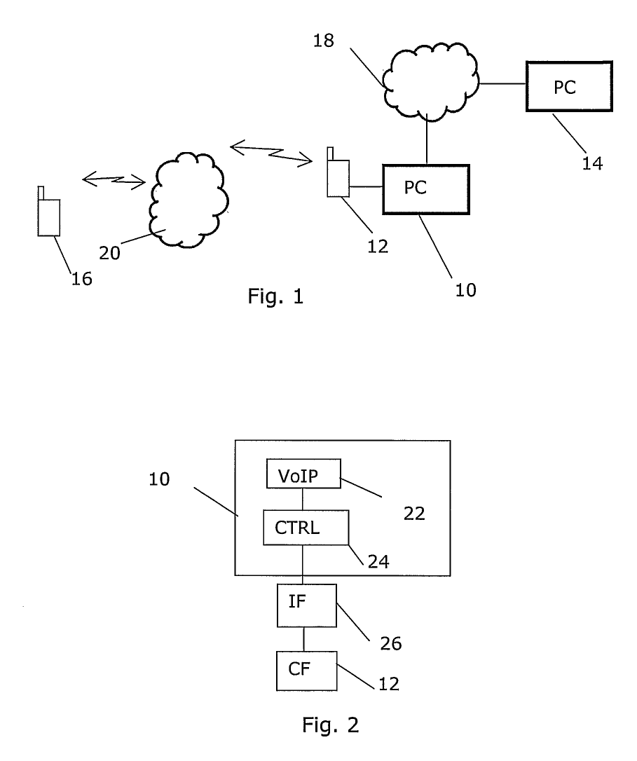

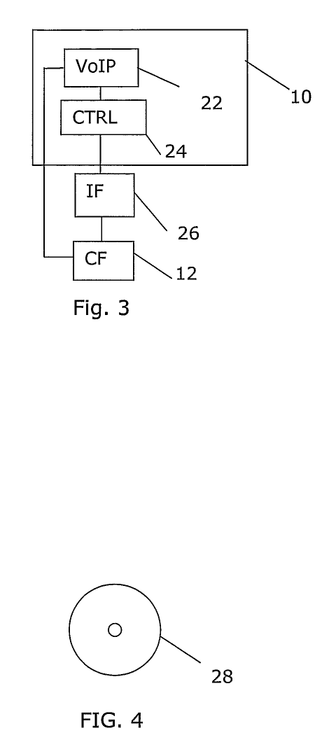

FIG. 1 schematically shows a computer telephony terminal according to the present invention comprising a first personal computer 10 and a first cellular phone 12 connected to each other. The personal computer 10 is also connected to a computer network 18. To this computer network 18 there is also connected a second terminal in the form of a second personal computer 14. The first cellular phone 12 is able to communicate with other cellular phones via a cellular network 20, where one such second cellular phone 16 is also shown. Both the computers are provided with peer-to-peer IP-telephony units.

The present invention is directed towards providing IP telephony to cellular phone users in a simple fashion. Because of this, the first computer 10 includes some different types of functionalities, where one is a voice-over-IP peer-to-peer telephony application 22, for instance the well known Skype type of telephone application. This application comprises among other things a contacts register sound compression functionality, echo cancellation functionality, IP telephony functionality and peer-to-peer networking connectivity functionality. This application will in the following be referred to as a computer telephony handling unit. The computer 10 does furthermore include a control unit 24, which controls the computer telephony handling unit 22 and some of the functionality of the first cellular phone 12. There is furthermore provided an interface unit 26, which may be part of the computer or a separate attachable interface unit for instance an interface unit connected to the computer using the USB connection. The first cellular phone 12 is connected to this interface unit 26.

The two cellular phones 12 and 16 are in the following assumed to be controlled by the same person, which is normally the user or owner of the first computer 10. Before being able to start using IP telephony the user registers the first and second cellular phone 12 and 16 in the control unit 24. Thus the identity of the second cellular phone 16 as well as the first cellular phone 12 are registered.

Now two scenarios are to be described regarding using IP-telephony using the first and second cellular phone.

In the first scenario a peer-to-peer voice-over-IP call is received by the computer telephony handling unit 22 of the first computer 10 from the second computer 14. Thus here the second computer 14 sets up a connection to the first computer via the computer network 18 and places a call to the computer telephony handling unit 22 via this connection. The computer telephony handling unit 22 informs the control unit 24 of this fact, which in turn goes on and orders the first cellular phone 12, via the interface unit 26, to set up cellular call to the second cellular phone 16 via the cellular network 20. Once this has been done, the telephone call can be conducted between a user, which is using the second cellular phone 16 and another party which is using the second terminal 14. Here the computer telephony handling unit 22 decompresses compressed voice, forwards it to the first cellular phone, which compresses the voice according to the voiced compression scheme used by the cellular network. In the opposite direction the first cellular phone decompresses compressed voice, forwards it to the telephony handling unit which compresses it for use in peer-to-peer voice-over-IP.

Now a second scenario will described where a call is placed by using the second cellular phone 16. Here the second cellular phone 16 informs the first cellular phone 12 that a call is to be made. This can according to one embodiment be made through placing an ordinary cellular phone call to the first cellular phone 12 via the cellular network 20. The first cellular phone 12 informs the control unit 24 via the interface 26. The control unit 24 here goes on and checks the identity of the second cellular phone 16 with stored trusted and known identities, typically identities the user has previously registered. Typically what is checked is the CLI information of the second cellular phone. If the check is a match, the control unit 24 provides the user with the possibility to enter an identity of a terminal he wishes to be called, for instance the identity of the second computer 14. It is however possible that it is any other terminal that is to be called. The user may then enter information about what terminal to be called. This can be by speaking and speech recognition or DTMF signalling. In this respect it is possible that an identity of the terminal or party to be called is entered and that the corresponding terminal identity is looked up in a contacts register provided in the computer telephony handling unit 22. A peer-to-peer voice-over-IP connection is then placed to the called terminal, for instance the second computer 14 and voice is transmitted between the second cellular phone and the second terminal over the thus established connection.

It is also possible that the connection is set up through the second terminal sending an instant message comprising the contact information, like an SMS or an MMS. Then the control unit may order the first cellular phone to set up the connection to the second cellular phone and the computer telephony handling unit to set up the connection to the other terminal over the computer network.

In this latter case there is one further variation that is possible. The instant message might also include another user terminal identity. The control unit may then order the computer telephony handling unit to set up two parallel connections and place a phone call to the terminal of the party to be called as well as a phone call to another terminal of the user. The control unit then orders the computer telephony handling unit to make a conference connection of the two calls. In this way it is possible for the user to obtain a call between two terminals where none of them is the second or first cellular phone.

According to another embodiment of the present invention, the first and second cellular phones have contact registers that are synchronised with each other and with the contacts, register provided in the computer telephony handling unit.

Because both the first cellular phone and the computer telephony handling unit are provided with echo cancellation functionalities, it is possible to provide the sound output of the computer telephony handling unit directly to the first cellular phone without passing through the interface unit. Thus it is possible for the control unit 24 to order the first cellular phone 12 to set up a call via the interface unit 26 and separately provide the sound from the speaker output of the computer directly to the headphones input of the first cellular phone 12. The phone 12 then takes care of the echo cancellation needed. Since echo cancellation is already provided in all cellular phones, the control unit and interface device can be kept very simple.

The present invention provides several advantages. It allows a user to lower his phone bills considerably in a simple manner, especially if the user is placing a lot of international calls. Since computer telephony is used, which is often provided at low or very small, costs, the remaining costs are the costs associated with the local cellular network. These costs are then often very low. In this way it is thus possible to provide a cellular phone user with the capability to place long distance or international calls at a cost that is virtually the same as the costs in a local network. By allowing a user to indicate another terminal than a cellular phone he is also able to lower costs if that cellular phone is for instance roaming in another cellular network.

The control unit according to the present invention is preferably provided in the form of one or more processors with corresponding memory containing program code.

The program code mentioned above can also be provided on a computer program product such as a CD ROM disc 28 as depicted in FIG. 4, which will perform the invention when loaded into the personal computer. Naturally other types of products can be provided for this, like for instance a removable memory like a memory stick. The computer program product can also be provided as software, which is downloaded remotely from a server.

1. Computer telephony terminal provided in a personal computer (10) and comprising: a computer telephony handling unit (22) arranged to set up and receive peer- to-peer voice-over-IP telephone calls to and from other terminals via voice-over-IP connections over a computer network (18), a first cellular phone (12) arranged to set up and receive cellular phone voice calls to and from other cellular phones via cellular voice connections over a cellular phone network (20), and a control unit (24) arranged to order the setting up of a voice-over-IP connection over the computer network to a second terminal (14) based on phone call information received by the first cellular phone from a second known cellular phone (16) via a the cellular network or to order the setting up of a cellular voice connection from the first cellular phone to the second known cellular phone based on a received voice-over-IP call from the second terminal received by the computer telephony handling unit via a voice-over-IP connection.

2. Computer telephony terminal according to claim 1, wherein the control unit is arranged to forward voice signals received by the computer telephony handling unit over the voice-over-IP connection to the first cellular phone for transmission over a cellular connection to the second cellular phone and to forward voice signals received by the first cellular phone over a cellular phone connection from the second cellular phone to the second computer over the voice-over-IP connection.

3. Computer telephony terminal according to claim 1, wherein the control unit is arranged to order the computer telephony handling unit to set up a parallel IP telephone connection to a third terminal based on phone call information received by the first cellular phone from the second known cellular phone via the cellular network and order the computer telephony handling unit to set up a conference connection between the two IP telephone connections.

4. Computer telephony terminal according to claim 1, wherein said phone call information comprises a terminal identity of the second cellular phone and the control unit is further arranged to compare the terminal identity of the second cellular phone with known and trusted terminal identities and
only order the set up of a call if the identity matches a known and trusted identity.

5. Computer telephony terminal according to claim 1, wherein the first cellular phone includes a register comprising contact identities together with corresponding terminal identities and the computer telephony handling unit also comprises a register comprising contact identities and corresponding terminal identities, wherein the control unit is further arranged to regularly synchronize the two registers with each other.

6. Computer program product (28) for setting up a telephone call between a user of a cellular phone and another party using a computer network via a personal computer having a computer telephony handling unit arranged to set up and receive peer-to-peer voice-over-IP telephone calls to and from other terminals via voice-over-IP connections over a computer network and to be connected to a first cellular phone arranged to set up and receive cellular phone voice calls to and from other cellular phones via cellular voice connections over a cellular phone network, said computer program product comprising computer program code, to make said personal computer execute, when said computer program code is loaded in the personal computer: order the computer telephony handling unit to set up f a voice-over-IP connection over the computer network to a second terminal based on phone call information received by the first cellular phone from a second known cellular phone via a the cellular network or order the first cellular phone to set up a cellular voice connection from the first cellular phone to the second known cellular phone based on a received voice- over-IP call from the second terminal received by the computer telephony handling unit via a voice-over-IP connection.

7. Method of setting up a telephone call between a user of a cellular phone and another party using a computer network comprising the steps of: Receiving, in a first computer telephony terminal, a peer-to-peer voice-over-IP telephone call from a second terminal via a voice-over IP connection set up by the second terminal over the computer network, and
Ordering a first cellular phone to set up of a cellular voice connection to a second known cellular phone via a cellular network, such that voice signals received by the computer telephony handling unit over the voice-over-IP connection can be forwarded to the first cellular phone for transmission over
the cellular connection to the second cellular phone and voice signals received by the first cellular phone over the cellular phone connection can be forwarded from the second cellular phone to the second computer over the voice-over-IP connection.

8. Method of setting up a telephone call between a user of a cellular phone and another party using a computer network comprising the steps of: receiving, from a first cellular phone, computer telephony phone call information that the first cellular phone has received from a known second cellular phone, and ordering the setting up of a voice-over-IP connection over the computer network to a second terminal based on said phone call information.

9. Method according to claim 8, further comprising the step of forwarding voice signals received by the computer telephony handling unit over the voice-over-IP connection to the first cellular phone for transmission over a cellular connection to the second cellular phone and forwarding voice signals received by the first cellular phone over a cellular phone connection from the second cellular phone to the second terminal over the voice-over-IP connection.

10. Method according to claim 8, further comprising the step of ordering the computer telephony handling unit to set up a parallel IP telephone connection to a third terminal based on phone call information received by the first cellular phone from the second known cellular phone via the cellular network and ordering the computer telephony handling unit to set up a conference connection between the two IP telephone connections.
